(19) United States
(12) Patent Application Publication
(10) Pub. No.: US 2016/0078549 A1
(43) Pub. Date: Mar. 17, 2016

(54) Life insurance with borrowed premium

(71) Applicant: Bijan Dokhanian, Beverly Hills, CA (US)

(72) Inventors: Bijan Dokhanian, Beverly Hills, CA (US); Zoltan Kemeny, Chandler, AZ (US)

(21) Appl. No.: 14/756,710

(22) Filed: Oct. 2, 2015

(51) Int. Cl. G06Q 40/08; G06Q 40/02

(52) U.S. Cl. CPC G06Q 40/08; G06Q 40/025

(57) ABSTRACT

Disclosed is a method, comprising lending for life insurance policy premium payments paid by a lender to the insurer, collateralized by seigniorage beneficiary of the lender, nominated by the policy owner as grantor of the premium payments, whereas upon the policy termination by a specified terminal event, occurred accidentally in the life of the insured, a predefined substantial part of the benefits are paid by the insurer to the lender, before other beneficiaries receive any further benefits, while, instead of the owner, the lender is allowed be the grantor. Also, a method, comprising lender buyout of the policy at instant surrender value, and lender paying annuities to the owner until the policy is terminated by the triggering event. Lander thereby continuously invests in a zero coupon bond of indeterminate but deterministic expiration date.

### FIELD OF THE INVENTION

This invention relates to financing life insurance for equity in beneficiary position. In particular, non-viatical landing by private STOLI as CQV co-beneficiary of assurance policy conditioned by at least one specified terminal event, which, by incapacitation, would result in complete economic value loss of the insured.

### BACKGROUND OF THE INVENTION

The invention fills the need for securing life insurance on elderly people who and whose relatives cannot afford such assurance without resorting to borrow for the premium, whereas when the insured dies, the lender would share the policy benefit. Apart death, terminal illness or incapacitation could also be a triggering terminal event and the private lander may be named as one non-exclusive beneficiary of a permanent life insurance policy, which do not loose surrender value and cannot be terminated unconditionally. Such financial security product could thus be discounted compounded as sinking surrender fund, from which annuities may be paid to beneficiaries other than the lander. Underwriters would thereby be protected from viatical fraud disguised in innocent charity.

Life insurance covers the economic losses incurred by the death or terminal/critical illness/injury/incapacitation of the insured person (triggering event). A life insurance owner (policy holder) contracts with an insurer (underwriter of the risk), promising to pay the premium (the cost of the policy) as needed (in a lump sum or by down-payment plus monthly installments up to a preset time in person or through a grantor), but no longer than the triggering event requires.

The triggering event terminates the policy and the insurer pays the benefits (the face value of the policy) to the beneficiaries, whom are named beforehand by the policy holder (if more than a single person is named). Policies may be surrendered for a cash value before the triggering event, but not unconditionally.

The sale of a life insurance policy to an investor for more than its cash surrender value, but less than its net death benefit, is termed viatical settlement. From the investor's perspective, that is equivalent buying a zero coupon bond of uncertain maturity date, with the obligation to pay its maintenance fee, the premium installments). This instrument is often used for terminally ill insured persons.

The case where the owner is not the insured (also referred as the celui qui vit or CQV), in order to prevent pure speculation on the insured's death, the owner must have an insurable interest by blood relation or business interest, thereby validating the presumed economic loss suffered by the owner upon the triggering event. Stranger originated life insurance (STOLI) is legal, but restricted to preserve the integrity of the life insurance business.

It shall be obvious that, for lacking funds, some cannot afford to sign any life insurance contract, no matter how badly is needed, at least to pay for the burial expenses.

The object of the invention is to help out such economically handicapped elderly and their concerned relatives. Also, to provide a novel and viable business model, which allows for suitably structured private landing for life insurance, by naming the lender as beneficiary in senior position. Also, to allow for instant redemption of such policy at estimated surrender value. Finally, to allow paying annuities to the policy owner, who may redeem other named beneficiaries at discount by passing to them a fraction of that annuity payment.

### SUMMARY OF THE INVENTION

The above problems and others are at least partially solved and the above objects and others realized in a process, which according to the teachings of this invention, uses a preferably private lending process, according to which:
a) a life insurance policy owner borrows form a lander to pay for the premiums of the policy;
b) the borrowed amount for that use is assessed based on the instant surrender value of the policy, which is lower than the face value of the policy;
c) though the premium payments are paid by the lender in behalf of the owner, the policy owner is the premium payments grantor, unless the lender assumes grantor position, should that be required by the insurer;
d) the owner names the lender as one beneficiary of the policy in senior position (to be paid first);
e) the policy owner names at least one other beneficiary in junior position (to be paid second, third, etc.), if not himself/herself;
f) the lender pays the premium (in installments or in full) in behalf of the policy owner;
g) upon the triggering of the policy termination by terminal incapacitation of the insured, the remaining balance of the loan is due in lump sum;
h) upon the receipt of that lump sum (balloon payment), lender forfeits its seniority right to be beneficiary, while otherwise exercises the seniority;
i) the other beneficiaries cashes the benefits of the policy due to them; and
j) the policy terminates irrevocably, whereas, optionally
k) the policy holder can be the same person as the borrower, grantor and junior position beneficiary;
l) after two years, but prior to naturally triggered termination, the owner may concede the right to the lender to surrender the policy, who then must surrender it at current surrender value; whereas
m) the lender must pay the owner the larger part of the benefit received thereby, either in lump sum or via a series of payments paid from an annuity fund set up and maintained by the lender;
n) the owner must indemnify the other named beneficiaries;
o) the policy terminates unchallengeable, and
p) the payment of annuities, without further due, automatically and instantly stops.

The permanent life insurances (whole life, variable life and universal life insurances) accumulate cash value, therefore are more suitable for this landing premium for life insurance benefits process.

Mortgaging this way at surrender value the policy to the lender who thereby annuitize it is less viable for term insurance than for permanent life insurances. Selling it, instead of mortgaging it, however by all means viable.

The instant surrender of a life insurance policy may be assessed based on reasonable assumptions about the occurrence of the triggering event, using standard actuary procedures. Under no circumstances must be assumed that the insured will decease within two years.

The fact that the lender and not the owner pays the premium, secures the insurer against early termination and lessens the chances for fraud.

The owner and the beneficiaries are helped beyond their means.

Thus, landing for life insurance premium, collateralized by the benefits is a win-win for the policy owner, the insurer, the beneficiaries and the lender. It contributes to economic growth.

### BRIEF DESCRIPTION OF THE DRAWINGS

Referring to the drawings:

FIG. 1 is a relationship diagram of the landing for premium method.

FIG. 2 is an operational flowchart of the premium payment process.

### DETAILED DESCRIPTION OF A PREFERRED EMBODIMENT

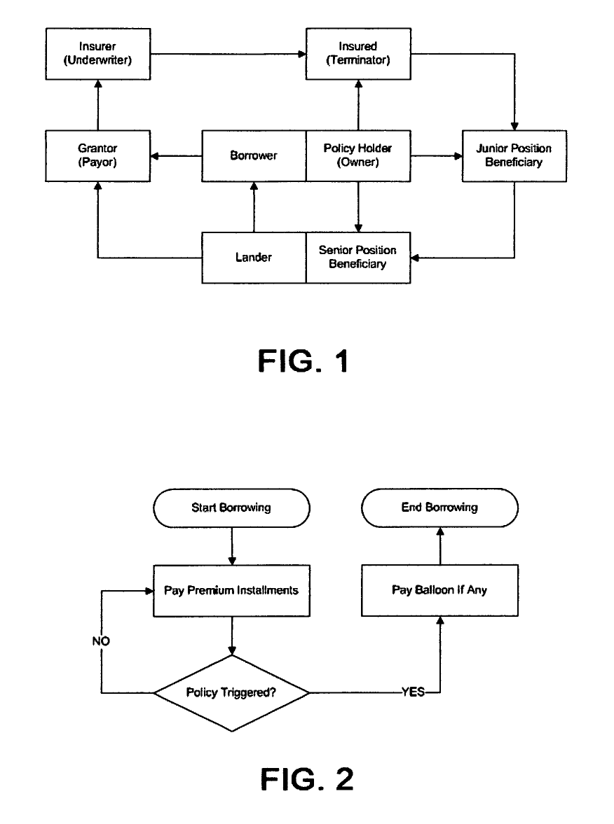

Attention is now turned to FIG. 1, which illustrates an exemplary relationship diagram of the landing for premium method, showing in separate block the participating legal entities and their connectivity through actions and responsibilities.

The key person is the Policy Holder (Owner), who needs loan to be able to sign a life insurance policy in behalf of the Insured (Terminator), whose life expectancy is the key factor in pricing the insurance premium and its benefits and whose circumstances can trigger the termination of the loan and the insurance policy, for instance by his/her death or terminal incapacitation. Thus the Owner, in need of funds, become a Borrower, who may or may not be the Grantor of the premium payment(s).

The Lender lends money to the Borrower and can be the Grantor of the premium payment(s). That is the preferred relationship. It guarantees that the Owner won't stop the premium payments before the triggering event happens. In any case, the Grantor warrant the premium payment(s) to the Insurer (Underwriter), who underwrite the risk of the triggering event, which in case of death, is a certainty.

The Insured (Terminator) role is passive here. The triggering event is required to be accidental, out of his/her control and its time of coming is uncertain, even though it may be well predicted within a future time window. The Insured is the “condition” in the life insurance contract's terms and conditions.

To secure the Lander that benefits remain to pay back his/her loaned money, he/she must be named by the Owner a Beneficiary of the policy, in fact, in first to get payed position, so he/she must be named by the Owner as the Senior Position Beneficiary of the policy.

The Owner however may name at least one other Junior Position Beneficiary in 2^{nd} position in the sequence the beneficiaries will get paid.

NO other legal entities involvement is required herewith.

Attention is finally turned to FIG. 2, which an exemplary operational flowchart of the premium payment process, as per the teachings of the invention.

Payment for the policy premium starts upon borrowing, whereas the lender makes the monthly payments to the insurer in behalf of the policy holder. The payment stream is on until is terminated by the triggering event, which is outside the control of both the lander and the insurer. Upon policy termination by natural triggering event, if any balloon payment is due, that will be paid, and the borrowing is terminated. No more payment is due thereafter.

When the lender buys the policy at surrender value, he/she may pay annuities the same way to the policy holder, following the same payment rule shown in FIG. 2. The instant surrender value of a life insurance policy can be taken 50% of the face value.

Example for the non-annuitized landing for life insurance policy premium:

Peter has no money to buy life insurance for his aging mother in non-failing health, who cooks for Peter, cleans his room and cooks for him. Thus, Peter would suffer emotional and economic losses, when his mother dies. Simply stated, Peter has an insurable interest in his mother's life and an obvious blood relationship. That qualifies him to obtain life insurance on his mother's life.

Peter is offered by No-Worries-Any-Financing (NWAF) Co. a 10-year term life insurance policy of $250,000 face value for $1,000/year premium payments, to be paid in equal monthly installments. NWAF also requires a $500 setup fee. The policy cannot be terminated within 2 years. The mother's death triggers the payment of the benefit to Peter.

Paul, contracts Peter to pay the expenses of the offered policy in exchange for 50% of the benefit. Paul, will not terminate the policy within 10 years and contractually bar Peter to terminate it any time. In the said contract, Paul requires Peter to name him, Paul, a beneficiary of the policy in first position, which requires NWAF to pay $125,000 to Paul first and $125,000 to Peter second, when Peter's mother dies. Paul grants all payments due for the policy to NWAF. Peter may designate other beneficiaries than himself, for instance his brother. Beneficiaries other than Paul, may share the $125,000 benefit as contracted with NWAF. NWAF is responsible to verify that the triggering event, the insured mother's death was natural.

This way, and the way further disclosed below, Peter, Paul and NWAF all benefitted.

Landing annuitized is similar. Instead of a lump sum received at his mother's death, Peter would get paid annually or monthly, even before his mother's death. A balloon payment would assure that Peter would not spend all the money received form Paul without saving for the funeral. In such annuitized landing, Paul may receive 100% of the benefit of $250,000. Paul, may pay a lump sum for that right. That would be a fraction of that total benefit. It would be equivalent to buying the policy at its estimated surrender value, say for $50,000.

The present invention is described above with reference to a preferred embodiment. However, those skilled in the art will recognize that changes and modifications may be made in the described embodiment without departing from the nature and scope of the present invention. For instance, if the policy holder is trusted enough by the lender he/she may receive the payments from the lender and pay (transfer) it to the insurer as grantor, and he/she may not name the lender to be beneficiary, for the lender may be a relative to the borrower-grantor-owner-beneficiary. Such modification is intuitive, hereby instructive and thus considered to be within the scope of this invention. Landing for life insurance premium on insured of any age, young or old, is also intuitive and within the scope of this invention.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Method comprising lending for life insurance policy premium payments paid by a lender to the insurer, collateralized by seigniorage beneficiary of the lender, nominated by the policy owner as grantor of the premium payments, whereas upon the policy termination by a specified terminal event, occurred accidentally in the life of the insured, a predefined substantial part of the benefits are paid by the insurer to the lender, before other beneficiaries receive any further benefits, while, instead of the owner, the lender is allowed be the grantor.

2. Method as per claim 1; whereas said owner is also the borrower, grantor and a beneficiary.

3. Method as per claim 1, whereas said owner is also the borrower and a beneficiary, while said lender is also the grantor and another beneficiary.

4. Method as per claim 1, whereas said terminal event is the death of the insured.

5. Method as per claim 1, whereas said terminal event is a permanent and irreversible incapacitation of the insured.

6. Method as per claim 1, whereas said policy cannot be terminated before said triggering event occur naturally.

7. Method comprising lending for life insurance policy premium payment paid by a lender to the insurer in a lump sum as full and final payment, equal to a negotiated surrender value of the policy, in an amount less than the face value of the policy, for the predefined part of the policy benefit, paid thereupon, whereas the lender annuitize it to the policy owner, paying annuity payments until the policy terminates by a specified terminal event, occurred accidentally in the life of the insured, upon which the insurer owes nothing more and the annuity payments stop, while the owner is allowed to concede the annuity payments to others all along.

8. Method as per claim 7, whereas said terminal event is the death of the insured.

9. Method as per claim 7, whereas said terminal event is a permanent and irreversible incapacitation of the insured.

10. Method as per claim 7, whereas upon said triggered policy termination, said lender pays a balloon payment to said owner.

11. Method as per claim 7, whereas said landing is on the balance of an active life insurance policy.

12. Method as per claim 7, whereas said policy is irrevocable and interminable within a preset time period.

13. Method as per claim 7, whereas said lump sum payment is annuitized to the insurer who pays only a fraction of said predefined part of the policy benefit.

14. Method as per claim 7, whereas upon said triggered policy termination, said lender pays a balloon payment to said insurer.
